(19) United States
(12) Patent Application Publication
(10) Pub. No.: US 2014/0089027 A1
(43) Pub. Date: Mar. 27, 2014

(54) SYSTEM AND METHOD FOR OUTSOURCING COMPUTER-BASED TASKS

(71) Applicant: Wendell Brown, Henderson, NV (US)

(72) Inventor: Wendell D. Brown, Henderson, NV (US)

(73) Assignee: Wendell Brown, Hunderson, NV (US)

(21) Appl. No.: 14/031,866

(22) Filed: Sep. 19, 2013

Related U.S. Application Data
(60) Provisional application No. 61/704,370, filed on Sep. 21, 2012.

(51) Int. Cl. G06Q 10/06

(52) U.S. Cl. CPC G06Q 10/06311
USPC 705/7.15

(57) ABSTRACT

A system and method are provided for outsourcing a computer-based task, such as modifying a document (e.g., text, an image), transcribing audio, performing research, translating from one language to another, etc. Outsourceable tasks are designed by service developers and posted on an exchange. Service providers bid on tasks they are qualified for, to indicate they will perform those tasks if paid the bid. Task buyers browse or navigate through the exchange to find what they need, and select a task based on its description, price and/or other factors (e.g., delivery time, language(s)). The exchange receives a task order (i.e., a purchased task), identifies qualified service providers and routes the task, with any required input, to a qualified provider who can complete the task before a deadline. Upon completion, the provider submits the completed task and any required output (e.g., deliverables) to the exchange, which forwards the output to the buyer.

### RELATED APPLICATION

This application claims priority to U.S. Provisional Patent Application No. 61/704,370, filed Sep. 21, 2012, which is incorporated herein by reference.

### BACKGROUND

This invention relates to the field of computer systems. More particularly, a system and methods are provided for outsourcing a computer-based task to a third-party.

The ability to outsource discrete tasks within an automated environment is limited. For example, an individual who desires to contract with someone else to perform a task such as proof-reading or editing a document generally must precisely define what is to be done, must find and select a person to perform the task, cannot proceed until someone bids on the work, may need to negotiate a price, etc. Even then, he or she is dependent on the selected person's purported level of skill, cannot browse tasks or workers ahead of time (i.e., before soliciting the work), must describe accurately what is to be done, and cannot purchase the work as soon as the need for it is recognized.

The outsourcer may fail to describe the desired task with sufficient particularity or definiteness, may be unable to differentiate between qualified and unqualified service providers, may fail to properly value the work to be done, or may make some other error that causes sub-standard results or an unsatisfactory experience.

### SUMMARY

In some embodiments of the invention, a system and methods are provided for outsourcing computer-based tasks. In these embodiments, an outsourcer or task buyer browses or navigates through available tasks on an exchange, until she finds what she needs. Each task will have a description of what it entails (i.e., what will be done, inputs, outputs), and the buyer may be able to examine descriptions of task providers available to perform the task on her behalf (e.g., with reviews of past work, ratings, skill levels).

New tasks are designed and added to the exchange by task developers, who are responsible for generating task descriptions, which may include identifying required and/or suggested skills, necessary or suggested tools (e.g., software applications), a price or fee (to be paid to the developer, a task provider, the exchange), a turn-around or delivery time, and/or other details. Task providers bid on tasks offered by the exchange, to indicate the prices for which they are willing to perform them.

When the buyer purchases a task and provides any necessary inputs (e.g., documents, recordings, images), the exchange selects an available task provider who can complete the task within a specified period of time, and routes the task to him or her. After completion of the task, the provider submits any specified deliverables to the exchange for delivery to the buyer.

### DESCRIPTION OF THE FIGURES

FIG. 1 depicts an environment in which computer-based tasks may be outsourced, in accordance with some embodiments of the invention.

FIG. 2 is a block diagram illustrating the system architecture of an exemplary exchange for outsourcing computer-based tasks, in accordance with some embodiments of the invention.

FIG. 3 is a flow chart demonstrating a method of outsourcing a computer-based task, in accordance with some embodiments of the invention.

### DETAILED DESCRIPTION

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In some embodiments of the invention, an individual or an organization (i.e., a service buyer) is able to outsource pre-defined computer-based tasks to service providers (which may also be termed service producers). For example, a buyer with a specific task to be accomplished may browse available services to find one that satisfies the task and that meets any other required criteria, such as time of completion, cost, level of skill of the service provider, etc.

The buyer is able to purchase the task or service immediately (e.g., as soon as the need for it is realized), and may conduct the transaction within an appropriate context. For example, if the task involves editing, proof-reading or other activity regarding a document the buyer is drafting or viewing, he may purchase the task using a control or interface offered within the word processor, spreadsheet program, database, imaging software or other application (e.g., as a plug-in or add-on). Or, the buyer may be able to procure the service by manipulating a control within a service tray, taskbar, menu or other interface presented by an operating system of a computer system or communication device.

Tasks are designed or defined by service developers, with sufficient detail to describe to a buyer what is offered and to describe to a service provider what to do to accomplish or fulfill the task, and may include specific inputs and outputs, actions to be taken, responsibilities of the buyer and provider, etc. In these embodiments, therefore, tasks are defined or designed by one entity (i.e., the service developer), purchased by another entity (i.e., the service buyer) and performed by yet another entity (i.e., a service provider).

One entity (e.g., an individual, an organization) may fulfill multiple roles. For example, within a single organization one individual or office may develop tasks, another (or the same) individual or office may provide the tasks, and yet another may purchase or requisition them. As another example, one private individual may design a task and also act as a provider for that task.

Different providers may perform the same task(s), but have different skills and experience, may charge different prices for their work, and will assemble different histories of service that may show, for example, if they finished tasks on time, how well they performed a task, and so on. A central exchange, market or system (e.g., a “task store”) may provide the automation framework for communicating among the parties, helping developers create new tasks, revealing available tasks to buyers, vetting service providers and assembling their histories, etc.

A buyer may not only browse available tasks or services, but also, in some implementations, select a preferred provider (or a set of preferred providers). In other implementations, however, a buyer simply buys a pre-defined task and the central exchange assigns the task to an appropriate provider, based on their work histories, their availabilities, how much they will charge and/or other factors.

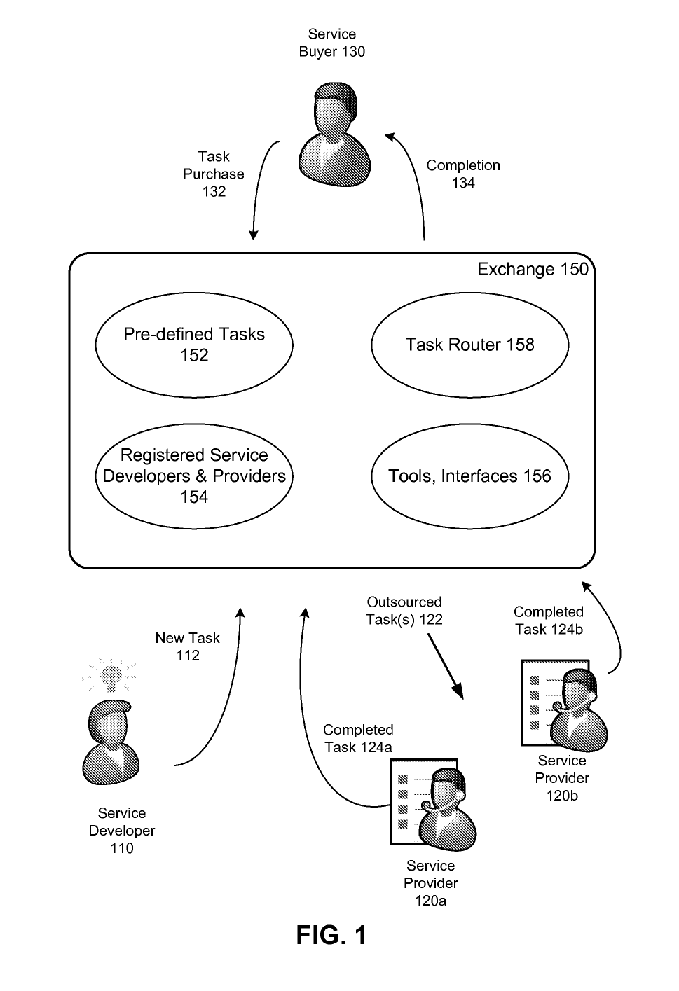

FIG. 1 depicts an environment in which computer-based tasks may be outsourced, according to some embodiments of the invention.

In FIG. 1, a new task is defined by service developer 110 and submitted to exchange 150. The task may be a new task (i.e., one not already available at the exchange), may slightly (or greatly) modify an existing task, or may accomplish the same thing as an existing task.

A task may be composed as one or more templates having different details. Such templates may differ according to any relevant detail(s), such as price, delivery time (e.g., as measured from the time the task is purchased by a buyer), minimum level of skill or experience required by a service provider in order to qualify for the task, etc. Designing new task 112 may therefore require developer 110 to identify inputs (by a buyer) and outputs (by a service provider) for the task, required or suggested tools (e.g., specific application programs and utilities), and as little or as much description of specific actions as is necessary to allow a buyer to determine whether satisfaction of the task accomplishes his/her goal and to inform a service provider of what he or she must do in order to successfully accomplish the task.

For example, a task of proof-reading or editing an English-language document might specify one or more word processing program formats in which the document shall be provided by a buyer and delivered by a service provider, a cost per page (or some other cost basis) to the buyer, a time to completion (e.g., 36 hours, 24 hours, to be specified by buyer), etc. The task may specify that the service provider will correct all misspellings (e.g., according to U.K. English, according to U.S. English), will correct grammar and/or style according to one or more specified sources (e.g., Oxford English Grammar, the Elements of Style), will correct punctuation, etc.

A task definition may specify (or suggest) one or more fees or costs, such as how much to charge a buyer for the task, how much the exchange will pay the developer (e.g., as a royalty), how much to pay the task provider, etc. A fee (whether or not included in a task's definition) may be fixed, may be negotiable, or may be expressed as a range.

If a range is identified for a buyer's cost, for example, the actual fee to be paid by the buyer may depend on the magnitude or nature of the task (e.g., number of pages in a document to be manipulated, whether the buyer is willing to pay more for faster delivery). If a range is identified for a provider's fee, for example, the actual fee to be paid to the provider may depend on the provider's bid for the work (e.g., assuming it is within the specified range), the provider's rating or skill, and/or other factors.

A fee, price or cost associated with a task, whether or not set by a task developer, may be per unit (i.e., per task), per unit of time (e.g., dependent on the amount of time required by a provider to complete the task, per unit of work (e.g., per page, per document), etc. A fee may have a maximum and/or a minimum.

New service developers may be required to register with exchange 150 before the exchange will accept new tasks from them, and one or more of their tasks may be reviewed by human operators of exchange 150 before those tasks are made available to service providers (for bidding on) and buyers (for purchase). As indicated above, service developers may receive a portion of money paid by purchasers of their tasks. Successful developers (e.g., those whose tasks are deemed well-designed and that sell well) may receive greater portions of prices paid by buyers. A service developer may be able to recommend one or more service providers and those recommendations may be passed on to prospective buyers.

Service providers 120 (e.g., providers 120a, 120b) receive outsourced tasks 122 purchased by buyers 130, perform the specified tasks and return the completed tasks 124 (e.g., tasks 124a, 124b) and any deliverables to exchange 150. Before a task 122 is assigned to a service provider, that provider must bid on the task by specifying how much he or she will charge to perform the work. Tasks are not necessarily assigned to the cheapest provider, but may be assigned based on several factors that include the providers' cost, their availability and their ability.

In particular, service providers may have rankings, ratings, skill levels or other badges or indicia indicating their relative levels of ability. These ratings may be assigned and monitored by exchange 150, may be independent of the exchange, may be affected by grades or scores awarded by buyers of their services, may increase or decrease over time, etc.

A service provider 120 may not only have a rating for a particular task offered to buyers 130 by exchange 150, but may also have ancillary or related ratings for skills that may apply to multiple tasks, such as English writing, Spanish speaking, Adobe Photoshop, Java programming and so on. Any or all of a provider's ratings may be considered by exchange 150 and/or a buyer 130 when selecting a provider for a task.

New service providers must register with exchange 150, identify their skills, and may be required to prove some level of ability or familiarization with subject matter associated with tasks they bid on. For example, exchange 150 may test a new provider's ability regarding some common skills, the provider's completed tasks may be reviewed or reviewed more carefully until he or she has performed the same task some threshold number of times (e.g., one, five), and/or the exchange may implement other quality controls.

When new task 112 is submitted to exchange 150, and after it is vetted, service providers 120 having associated skills (e.g., skills specified or identified by developer 110) may be automatically notified of the new task and be invited to bid on it. A service provider may adjust his or her bid, such as to lower it and receive more work, or to raise it to reflect her increased skill. A service developer 110 may also be a provider 120, and vice versa.

Buyer 130 visits exchange 150 via a web site or other presence operated by the exchange, either directly (e.g., via a browser or other interface provided by the exchange) or via a control offered within an application program/utility or by an operating system of her computing device and/or communication device. The buyer purchases a task 132 that accomplishes what she needs and, when it is done, receives completion 134, which may be an edited document, a modified image, a transcribed recording and/or any other deliverable specified in purchased task 132.

A control activated by buyer 130 to access exchange 150 may be embedded in application programs associated with tasks offered by the exchange (e.g., Microsoft Word, Mozilla Firefox, Google Office). For example, the control may be activated on a mobile device (e.g., a portable computer, a smart phone) or a stationary device (e.g., a desktop computer or workstation) executing a compatible application.

Exchange 150 is a framework for connecting developers 110, providers 120, and buyers 130, and enables communication among these parties via electronic mail, real-time messaging, file-sharing and/or other utilities. Exchange 150 collects purchase prices from buyers 130 and distributes proceeds to developers 110 and/or providers 120.

The exchange may provide quality control measures by dropping service providers that cannot or will not perform satisfactorily, and enforces the terms of a task (e.g., what will or will not be done) against buyers who expect work beyond what is specified in the task and against providers who may attempt to avoid performing all actions specified for a task.

Exchange 150 includes pre-defined tasks 152 that have been designed by developers 110, that may or may not be approved or vetted by the exchange, that are bid upon by providers 120 and that are available to buyers 130.

The exchange also maintains profiles 154 of approved developers and providers, which may identify their skills, areas of expertise, ratings, recommendations, work histories, their commissions/fees/bids, and so on. The exchange may also store profiles of buyers, so that a buyer can review (and repeat, if desired) a previous purchase, identify a provider of a purchased task, etc.

Tools and interfaces 156 include various automated tools and interfaces available to any or all of developers 110, providers 120 and buyers 130. For example, software tools may be offered to developers to define new task templates, modify existing templates, see how well their tasks are selling, determine which providers have been performing their tasks (e.g., and how well they do), etc. Providers may have access to tools that test or verify their skills, that are usable to complete a task, to submit bids on new tasks, upload deliverables, etc. Buyers may access exchange 150 through controls or interfaces provided by the exchange that allow them to browse tasks, peruse reviews of tasks submitted by other buyers, examine providers' histories/reviews, etc.

Task router 158 of exchange 150 receives purchases of tasks from buyers 130, routes them to service providers 120, receives completed tasks and returns deliverables to the buyers. Many factors may be considered to determine which service provider receives a particular outsourced task 124, including buyer requests for particular providers (e.g., providers that previously performed tasks for them), their availabilities, their bids, their histories of on-time delivery and quality, buyer feedback (e.g., regarding on-time delivery and/or quality), skill levels/ratings, requirements specified in the task definition (e.g., certain skills and/or skill ratings, access to a particular software application), etc.

In some implementations, a service developer may specify that a task can only be assigned to pre-approved providers (e.g., providers pre-approved by the developer and/or the exchange). In some implementations the process of assigning tasks to providers is fully automated.

When a particular service provider 120 is selected for an outsourced task, he or she is notified and may have a limited period of time to accept or reject the assignment. If the task is rejected, a different provider will be selected. If accepted, the provider must confirm any deadline for delivery of specified output to exchange 150. Failure to meet these deadlines will cause the provider's rating (or at least a “timeliness” or similar aspect of the rating) to decrease accordingly.

If no providers are available for a task, or if no providers confirm the ability to complete the task by a deadline, a buyer may be informed and may accept “late” completion, may rescind the order, select a different task, offer to pay more, or take some other action.

In some embodiments of the invention, the developer of a new task may specify the price for which it is to be offered and/or the amount (or the maximum amount) that a service provider will be paid if a buyer purchases the task and the provider receives the outsourced task. In some other embodiments, the developer may identify a range of prices and/or a range of fees to be paid to the provider who does the work, and any service provider that bids no more than the maximum may qualify to receive the task.

In yet other embodiments, either or both of the price to the buyer and the fee to be paid to a service provider depend on what the buyer offers to pay and what a service provider bids (i.e., how much he or she will do the work for). If a buyer does not offer enough, his or her task may not be performed.

A service provider may pre-bid on a task to indicate how much he or she will do the work for, before a buyer purchases the task, in which case the buyer may be informed of a minimum price that must be paid. This price may cover the provider's bid, any royalty or fee to be paid to the developer of the task, and any fee or surcharge to be paid to exchange 150.

Alternatively, a service provider may bid in real-time after a buyer makes an offer. For example, after the buyer enters his offer, one or more providers of the task may be notified and may be able to offer bids or may be informed that they will receive the task if they agree to accept a particular fee. Fees offered to different provider may differ according to their skill level or rating, their experience with the task, their availability, etc. As indicated above, the buyer may select or request a particular provider or one of a set of providers if, for example, they previously completed tasks in a satisfactory manner for him.

In some embodiments of the invention, therefore, a buyer is able to quickly browse available tasks and immediately purchase one. Tasks may be accompanied by information indicating whether any service providers qualified to perform that task are currently available, how many are available, ratings of those that are available, how many times a provider has previously completed the task, comments by previous buyers for whom the provider has performed the task, etc.

A task purchaser may be able to request or specify criteria for selecting a service provider for a chosen task (or, as already described, may request a specific provider). Such criteria may include cost (e.g., the provider's bid for doing the work), certifications held by the provider, rating by the exchange, reviews by other buyers, timeliness, location of provider, primary language, age, gender, experience, etc.

Available tasks may be categorized in various ways for browsing or shopping by a buyer, such as by general description (e.g., document proof-reading, photo touch-up), by the name of a software application involved in the work (e.g., Adobe Photoshop, Mozilla Firefox, Google Office), and/or in other ways.

Illustrative tasks that may be outsourced in embodiments of the invention include manipulation of virtually all types of documents, images and videos, including editing, re-formatting, touching-up, creation, translation, and so on. Some specific examples include editing or proof-reading a textual document, editing a photograph (e.g., to remove or change an object, make a subject appear younger or older, remove red-eye), transcribing a recording into text, performing research on a particular topic (using specified and/or unspecified sources), transcribing written information (e.g., from business cards, from written records) into electronic form (e.g., as contacts, as mailing labels), processing audio (e.g., to remove static, flutter), etc.

In some embodiments of the invention, a completed task from a service provider is followed by additional work by another service provider or by another party. For example, a task purchased by a buyer may entail a sequence of two or more sub-tasks performed by the same or different service providers, such as proof-reading a document written in English and then translating it into Mandarin Chinese. Or, the task performed by the service provider may involve computer-based work (e.g., to digitize a hand-drawn image), and may be followed by physical use of the service provider's work (e.g., to print the image on clothing, banners or other media). In these examples, the buyer may purchase a single task and the exchange manages the multiple sub-tasks necessary to complete the task.

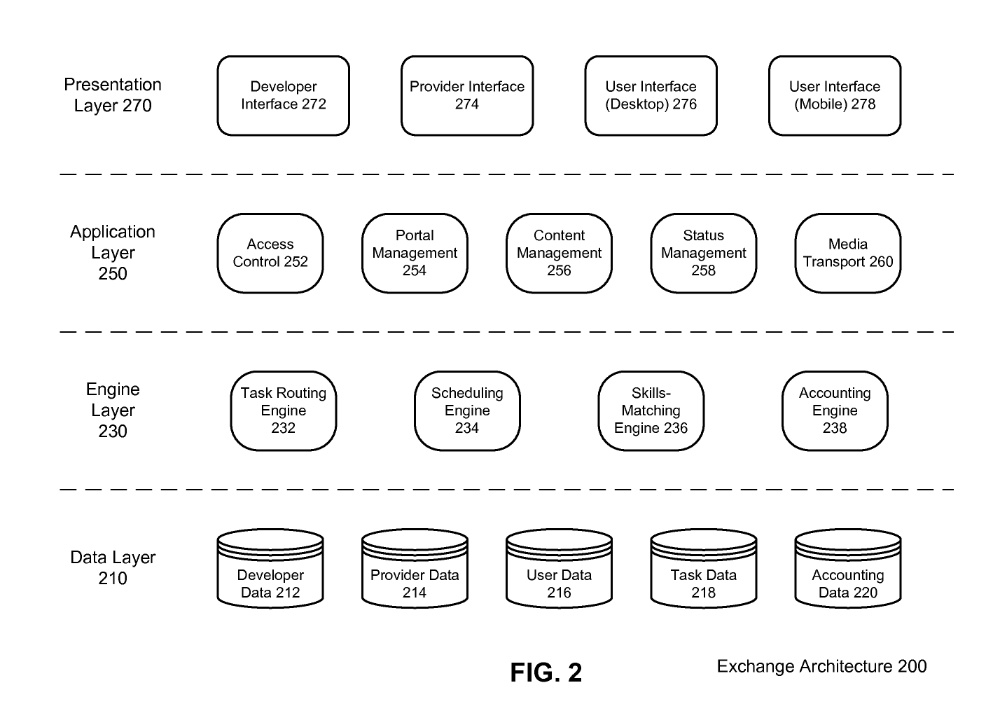

FIG. 2 is a block diagram illustrating the system architecture of an exemplary exchange or marketplace for outsourcing computer-based tasks, according to some embodiments of the invention. The illustrative system architecture 200 includes four layers: data layer 210, engine layer 230, and application layer 250 and presentation layer 270. In these embodiments of the invention, “outsourcing” a task is synonymous with “purchasing” an available computer-based task to be performed by someone other than the purchaser

Within data layer 210, developer data 212 includes information regarding service developers, such as profiles (e.g., name, electronic mail address(es), social media login identities, password(s)), qualifications, tasks they've designed or are designing, popularities (e.g., sales) of their tasks and so on. Provider data 214 includes information regarding service providers, such as profiles (e.g., name, electronic mail address(es), social media login identities, password(s)), qualifications, experience, tasks they've performed, ratings earned for specific skills and/or tasks, schedules of availability, reviews of their work (e.g., by buyers, by developers), bids for tasks, etc. User data 216 includes information regarding buyers/users, such as profiles (e.g., name, electronic mail address(es), social media login identities, password(s), credit card and/or other payment information), tasks they've purchased (i.e., their purchase history), reviews they've written regarding tasks (i.e., their feedback history), providers and/or developers, preferred service providers, and so on.

Task data 218 identifies tasks available for purchase via the exchange, the tasks' service specifications, instructions (e.g., to service providers) for performing the tasks, necessary tools (e.g., software applications) for accomplishing the tasks, costs (e.g., to be paid to developers and/or providers, pricing terms), delivery terms, order histories for each task, feedback that has been submitted regarding the tasks, identities of service providers that have previously performed the task (and their performance, feedback), etc. Accounting data 220 may store information regarding every purchase, amounts collected from or billed to buyers, payments to developers and providers, taxes paid, fraud management information (e.g., buyers' charge-back histories), buyer credits/discounts/coupons, and/or other financial data.

Within engine layer 230, task routing engine 232 routes outsourced/purchased tasks to appropriate service providers, possibly using other components of engine layer 230 and/or of other layers of architecture 200. In some embodiments, upon purchase of a task, routing engine 232 first identifies service providers that have been pre-approved to perform the task, and determines which ones are available (i.e., are able or likely to be able to complete the task within the specified time). Second, this list of candidate providers may be expanded to include providers that are not pre-approved but who otherwise are (or appear to be) qualified (e.g., based on skills, experience, education), and who can complete the task in time. Third, the list of candidates is ranked (e.g., with a weighted point system) and the task is routed or offered to the top-ranked candidate. If that candidate turns out to be unavailable, or unable to deliver the task in time, or if he/she rejects the task, the task is given to the candidate with the next highest rank.

Scheduling engine 234 handles delivery of tasks to selected service providers, and may confirm those providers' ability to complete the tasks on time. For example, in some embodiments, the scheduling engine requires a selected provider to verify his or her ability to meet the delivery deadline before delivering the task to the provider. If the provider does not confirm receipt of (or availability for) the assignment, or fails to meet an intermediate (or final) deadline or otherwise show progress, scheduling engine 234 may re-assign a task to the next candidate. The scheduling engine may be updated on a regular basis to indicate providers' statuses (e.g., working on a certain task, idle, on vacation, available).

Skills-matching engine 236 matches tasks with providers. In some embodiments, service providers who match a task's necessary or suggested skills (e.g., as identified by the task's developer) are invited to be pre-approved for the task. In one implementation of these embodiments, the task's service developer examines a candidate provider's qualifications (e.g., skills, experience, work history, feedback history) and decides whether or not to allow the provider on the pre-approved list. This review may be anonymous (e.g., the provider and/or developer may not be advised of the other's identity).

In some other embodiments, skills-matching engine 236 matches providers against a task's associated skills, and rates or ranks providers based on how closely they match (or how much they exceed) the required or suggested levels of proficiency for the skills. In these embodiments, the task's service developer lists skills necessary to complete the task and, for each skill, one or more levels of proficiency (e.g., minimum level of competence to perform the task, suggested level of ability, minimum level to be automatically pre-approved).

Accounting engine 238 ensures proper payment to developers and providers, and proper charges to buyers. The accounting engine therefore includes billing logic for executing purchase transactions, calculating and applying taxes, collecting money from the buyer, making payments to service developers and service providers, etc. Accounting engine 238 also includes logic for initiating credit card transactions and detecting fraud.

Within application layer 250, access control module 252 ensures buyers are authenticated (e.g., when they login to the exchange) and that only registered and qualified developers and providers are able to submit new tasks and receive outsourced tasks. More specifically, module 252 enforces access controls on buyers/users, service developers, service providers and operators of architecture 200. In one implementation, authorization is performed by way of the OAuth open standard for authorization. In another implementation, buyers, developers, providers and operators have assigned identifiers or usernames with which they login.

Portal management module 254 manages information produced and/or used by various components of architecture 200, for presentation to buyers, service developers and/or service providers to facilitate their use of the system in purchasing tasks, developing tasks, performing tasks, etc. The portal management module helps them view and manage necessary and desired information.

Content management module 256 stores and manages content and information that a service provider may need. Such content may include, for example, data templates, background pictures, processes, script files, filters, setting and/or other data. Content managed by module 256 may be provided by server developers and/or other entities, to help service providers complete assigned tasks.

Status management module 258 manages workflow information, which allows statuses of new tasks and outsourced tasks to be monitored. In some embodiments, a service provider's updates regarding the progress of a task are reported to status management module 258, which allows the buyer of the task to obtain a real-time view of the progress, a projected time of delivery of any deliverables, etc.

Media transport 260 provides for movement (e.g., transfer, delivery) of data within architecture 200. In some embodiments, a third-party file transfer service (e.g., iCloud, Dropbox, Skydrive) may be employed. In other embodiments, electronic mail, File Transfer Protocol (FTP) or some other data transfer mechanism or scheme may be used. The media transport may interface with data storage components and/or input/output components of mobile devices (e.g., a smart phone), to capture content or send/receive information.

Within presentation layer 270, developer interface 272 manages an interface used by service developers to submit new tasks, possibly to help them design tasks (e.g., with a studio software application designed to support standardized formats for tasks), update or check on the statuses of tasks they've submitted, etc. The developer interface may also include or provide a login function, status information, checking and verification tools, accounting information, mappings of a developer's tasks to pre-approved service providers, etc. Developer interface 272 may be configured as a web site or as a page of a web site.

Provider interface 274 manages an interface used by service providers to bid on tasks, receive outsourced tasks, submit completed tasks, and so on. In some embodiments, the provider interface includes or provides a login function, a list of tasks assigned to a provider, status information regarding those tasks, upcoming deadlines, quality assurance and verification tools, accounting information, a list of tasks the provider has been pre-approved for, etc. Provider interface 274 may be configured as a web site or as a page of a web site.

User interface (desktop) 276 manages a robust interface employed by users/buyers to outsource computer-based tasks. Interface 276 may include controls, plug-ins and/or add-ons to software applications used by task buyers and/or to operating systems of robust (e.g., desktop, workstation) computing devices they operate. In some embodiments, the user interface (desktop) includes or provides a login function, a list of purchasable tasks, purchase mechanisms and instructions, messaging screens, notification areas, a list of previously purchased tasks, statuses of purchased tasks that have not yet been completed, upcoming deadlines, etc. Tasks may be organized by category, price, delivery time and/or other criteria. User interface (desktop) 276 may be configured as a web site or as a page of a web site.

User interface (mobile) 278 provides access to the exchange for users/buyers similar to user interface (desktop) 276, and may include any or all of the features identified above, but may be light-weight in design, for use on a mobile communication (or computing) platform, such as a smart phone. The user interface (mobile) may be configured as an HTML (Hyper-Text Markup Language) or HTML 5 web site (or as a page of such a site) designed for a smaller display screen. In some embodiments, user interface (mobile) 278 may be a native application (e.g., for iPhone, Android).

Ranking service providers (e.g., by task routing engine 232) for determining who will receive an outsourced or purchased task may rely on any number of various attributes of those providers, and/or other factors tracked by the exchange. Different factors may be considered, with different weights, in different embodiments.

For example, in some embodiments, factors such as those delineated in Table 1 are used to generate the weighted rankings As shown in Table 1, each factor has an associated weight and, for factors that have multiple possible values (or ranges of values), each value (or range of values) maps to a different number of points. Although a maximum of three levels of values are depicted in Table 1, any number of levels may be implemented.

When Table 1 is applied to generate weighted rankings for a task that has been purchased, each service provider considered for the task is initially assigned zero points. He or she accumulates additional points depending on how his or her attributes correlate with the factors of Table 1.

For example, a first provider who has an Availability of “Now,” a Quality Rating (QR) of 76%, an On-Time Delivery (OTD) of 95% and an Experience Level (EL) of 0.77 will receive the following points: (30×10)+(8×2)+(4×10)+(3×4)=368. A second provider having an Availability of “<15 minutes,” a QR of 82%, an OTD of 91% and an EL of 0.86 will receive the following points: (30×6)+(8×5)+(4×7)+(3×6)=266. Thus, each service provider considered for the task will receive some number of Total Points, which will be used to rank him or her. The system (e.g., scheduling engine 234) then assigns the task to the highest ranked service provider who accepts it.

TABLE 1

| Factor | Weight | Level 1 | Pts | Level 2 | Pts | Level 3 | Pts |
|---|---|---|---|---|---|---|---|
| Availability | 30 | Now | 10 | <15 min | 6 | <30 min | 4 |
| Quality Rating | 8 | >90% | 10 | >80% | 5 | >70% | 2 |
| On-Time Delivery | 4 | >95% | 10 | >90% | 7 | >85% | 4 |
| Experience Level | 3 | >0.8 | 6 | >0.6 | 4 | | |
| Pre-Approved | 2 | Yes | 1 | | | | |
| Language | 2 | >90% | 5 | >80% | 3 | >70% | 1 |
| Proficiency | | | | | | | |

In other embodiments of the invention, factors similar to or different from those depicted in Table 1 may be applied, with similar or different weights and points. For example, service providers that were pre-approved for a task may receive an extra X points, service providers that previously received good feedback from the purchaser of the currently purchased task (e.g., with an indication that the purchaser would outsource to that provider again) may receive an extra Y points, etc.

In some embodiments of the invention, the “Availability” factor for a service provider (e.g., as reflected in Table 1) may be derived from the provider's current status as reported by the provider and/or captured by status management module 258 or some other component of exchange 200. The “Quality Rating” factor may be derived from feedback provided by task purchasers whose tasks were performed by the provider. The “On-Time Delivery” factor may be determined by comparing the timing of deliverables provided by the provider with the deadlines for those deliverables. The “Experience Level” factor may be derived from the number of times the provider has previously performed the current task and/or experience with similar tasks (e.g., different tasks that employ some or all of the same skills).

In some embodiments of the invention, the weights and factors that are used to rank service providers may depend upon the task, the purchaser and/or other parameters. The weightings of Table 1, for example, which assign a high weight to the “Availability” factor, may be particularly suitable for choosing a service provider for a short task that has a very tight deadline (e.g., 30 minutes from the time the task is purchased). For tasks that don't have such short deadlines, weights and/or points may be very different from those of Table 1.

As another example, for a purchaser who uses/knows only the Pashto language, or for a task that requires language skills (e.g., transcribing a recording, editing text) a Language Proficiency factor may be more important (and weighted more) than another factor, or even more than all other factors. In this example, the set of weights that is applied may therefore depend (at least partially) on the purchaser; for a purchaser whose primary language is more common, different weights may apply that make the Language Proficiency factor less important.

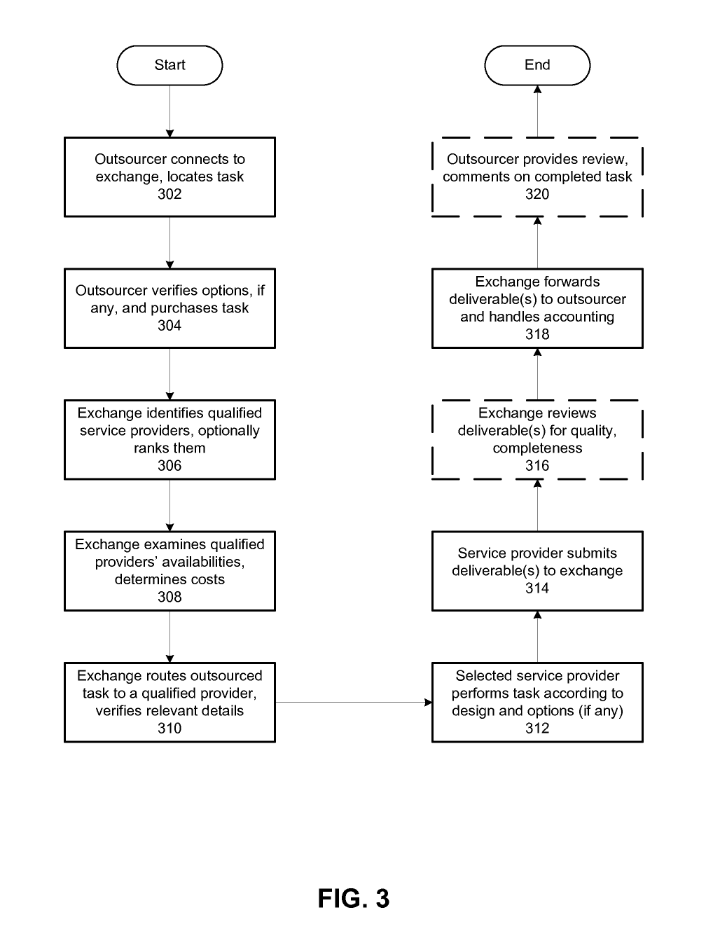

FIG. 3 is a flow chart demonstrating a method of outsourcing a computer-based task, according to some embodiments of the invention.

In operation 302, a prospective task outsourcer or buyer connects to an exchange or service that facilitates outsourcing of computer-based tasks, and browses or navigates to a particular task that accomplishes the buyer's goal(s). Navigation through the exchange and available tasks may differ from one implementation to another, but the starting point (e.g., a first page the buyer sees upon connection) may depend on how the buyer connected. For example, if he connects via a control of a particular application, he may initially be presented with tasks that involve that application.

In operation 304, the buyer selects or verifies any options, as necessary, and makes his purchase. Such options may indicate when the output or deliverable(s) are due, a price to be paid, a format or other formal requirement (e.g., resolution, color, language), one or more preferred task providers, etc. Multiple tasks may be purchased together, to be satisfied by the same or different provider(s), and the purchased tasks(s) include full descriptions of the work involved.

In operation 306, the exchange identifies service providers, if any, that are qualified to perform the purchased task(s). They may be identified before the purchase is made in operation 304. As described above, for example, service providers may be able to bid on a task anytime after it is registered and added to the exchange and, if their skills are considered sufficient, may be thereafter automatically considered for the task when it is purchased.

As part of operation 306, the exchange may rank some or all of the qualified service providers based on ability, ratings (regarding the task, ability to meet deadlines, and/or other factors), skill levels, and/or other criteria.

In operation 308, the exchange determine the availabilities of some (e.g., the most qualified, the cheapest) or all of the qualified task providers, and may determine how much they cost (i.e., what they bid for the task). Providers that are certain to be unavailable in time to complete the task before a deadline may be eliminated from consideration.

In operation 310, the exchange selects a task provider and routes the work to her, and may possibly verify that the selected provider can meet one or more specified criteria or options (e.g., delivery time, knowledge of use of a particular tool). This operation may also include delivering to the selected task provider any input submitted by the buyer (e.g., a document, an image, a recording, a drawing).

In operation 312, the selected service provider performs the task as specified in the task's design and as requested by the buyer. The exchange may or may not provide tools (e.g., software applications) to assist the provider.

In operation 314, the service provider completes the task and submits any output (i.e., deliverables) to the exchange.

In optional operation 316, the exchange may review the output of the service provider to ensure terms of the task were satisfied and verify that the work is of acceptable quality. This step may be omitted in some circumstances, such as after the service provider has performed the same task a threshold number of times with acceptable quality.

In operation 318, the exchange forwards the deliverable(s) to the task buyer and may perform any necessary accounting if not done beforehand, such as charging the buyer, sending proceeds to the task developer and/or service provider, etc.

In optional operation 320, the outsourcer reviews the output of the task to verify that it satisfied what she needed and expected, and may comment on the completed task, the service provider and/or some other aspect(s) of the process.

An environment in which some embodiments of the invention are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which can be stored in a non-transitory computer-readable storage medium as described above. When a processor or computer system reads and executes the code and manipulates the data stored on the medium, the processor or computer system performs the methods and processes embodied as code and data structures and stored within the medium.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A method of outsourcing a computer-based task, the method comprising:
receiving from a first task developer a definition of a first task comprising multiple operations;
receiving a connection from a task buyer;
displaying to the task buyer multiple tasks, including the first task;
in response to the task buyer's selection of the first task:
identifying multiple service providers qualified to perform the first task;
determining availabilities of the multiple service providers; and
routing the first task to a selected service provider;
receiving one or more electronic deliverables upon completion of the first task by the selected service provider; and
delivering the one or more electronic deliverables to the task buyer.

2. The method of claim 1, further comprising:
facilitating browsing of the multiple tasks for immediate purchase based on one or more goals of the task buyer.

3. The method of claim 1, further comprising:
verifying that the one or more electronic deliverables satisfy terms of the first task identified in the definition of the first task.

4. The method of claim 1, further comprising registering the multiple service providers, wherein registering a first service provider comprises:
receiving a registration application from the first service provider;
identifying one or more skills of the first service provider; and
verifying the one or more skills of the first service provider.

5. The method of claim 4, wherein said verifying comprises one or more of:
testing the one or more skills of the first service provider; and
confirming a certification of the first service provider.

6. The method of claim 4, further comprising:
notifying the first service provider of the first task definition; and
receiving a bid for the first task from the first service provider;
wherein the bid signifies that the first service provider will perform the first task for a value identified in the bid.

7. The method of claim 1, wherein receiving a connection from a task buyer comprises activation, by the task buyer and within a first application program, of a control associated with outsourcing a task associated with the first application program.

8. The method of claim 1, wherein the definition of the first task specifies:
input required from the task buyer;
the one or more electronic deliverables from the selected service provider; and
one or more operations to be performed on the input.

9. The method of claim 8, wherein the definition of the first task further comprises fees to be paid to one or more of:
the first task developer; and
the selected service provider.

10. The method of claim 1, wherein the first task is routed to the selected service provider without identifying the selected service provider to the task buyer.

11. A non-transitory computer-readable medium storing instructions that, when executed by a processor, cause the processor to perform a method of outsourcing a computer-based task, the method comprising:
receiving from a first task developer a definition of a first task comprising multiple operations;
receiving a connection from a task buyer;
displaying to the task buyer multiple tasks, including the first task;
in response to the task buyer's selection of the first task:
identifying multiple service providers qualified to perform the first task;
determining availabilities of the multiple service providers; and
routing the first task to a selected service provider;
receiving one or more electronic deliverables upon completion of the first task by the selected service provider; and
delivering the one or more electronic deliverables to the task buyer.

12. A system for outsourcing a computer-based task, comprising:
one or more processors; and
memory storing instructions that, when executed by the one or processors, cause the system to:
receive from a first task developer a definition of a first task comprising multiple operations;
receive a connection from a task buyer;
display to the task buyer multiple tasks, including the first task;
in response to the task buyer's selection of the first task:
identify multiple service providers qualified to perform the first task;
determine availabilities of the multiple service providers; and
route the first task to a selected service provider;
receive one or more electronic deliverables upon completion of the first task by the selected service provider; and
deliver the one or more electronic deliverables to the task buyer.

13. A method of outsourcing a computer-based task, the method comprising:
receiving from a first task developer a definition of a first computer-based task comprising multiple operations;
receiving from a first service provider an indication of willingness to perform the first task;
receiving a purchase of the first task from a task buyer;
in response to the task buyer's purchase of the first task:
identifying multiple service providers qualified to perform the first task, including the first service provider;
determining availabilities of the multiple service providers; and
routing the first task to a selected service provider;
receiving one or more electronic deliverables upon completion of the first task by the selected service provider; and
delivering the one or more electronic deliverables to the task buyer.

14. Apparatus for outsourcing a computer-based task, comprising:
one or more processors;
developer interface logic executed by the one or more processors and operated by a service developer to design the computer-based task as a series of one or more discrete computer-based operations;
user interface logic executed by the one or more processors and operated by a task buyer to purchase the computer-based task;
task routing logic executed by the one or more processors to select, from one or more service providers qualified to complete the computer-based task, a first service provider to receive the computer-based task;
scheduling logic executed by the one or more processors to determine availabilities of the one or more service providers to complete the computer-based task by a predetermined deadline; and
provider interface logic executed by the one or more processors and operated by the first service provider to receive the computer-based task and to submit a deliverable produced by the computer-based task.

15. The apparatus of claim 14, further comprising:
skills-matching logic executed by the one or more processors to identify the one or more service providers qualified to complete the computer-based task.

16. The apparatus of claim 15, wherein the skills-matching logic identifies the one or more service providers by matching a set of skills identified by the service developer, while designing the computer-based task, with skills of a pool of service providers.

17. The apparatus of claim 14, further comprising:
status management logic executed by the one or more processors to monitor a status of the computer-based task after receipt of the computer-based task by the first service provider.

18. The apparatus of claim 14, wherein the task routing logic comprises executable by the one or more processors to:
identify the one or more service providers qualified to complete the computer-based task; and
rank the one or more service providers based on their skills and based on weights associated with the skills.
